(19) United States
(12) Patent Application Publication
(10) Pub. No.: US 2007/0025540 A1
(43) Pub. Date: Feb. 1, 2007

(54) Call center routing based on talkativeness

(76) Inventor: Roger Travis, Cambridge, MA (US)

Correspondence Address: FISH & RICHARDSON PC, P.O. BOX 1022, MINNEAPOLIS, MN, 55440-1022, US

(21) Appl. No.: 11/176,061

(22) Filed: Jul. 7, 2005

(51) Int. Cl. H04M 7/00

(52) U.S. Cl. 379/219

(57) ABSTRACT

Methods and systems for routing calls to a customer service representative are disclosed.

### BACKGROUND

The invention relates to call centers and methods and systems for routing calls.

Call centers are used by organizations to receive calls from callers or customers, take orders, answer questions, and/or provide information about a service. For example, call centers are used by mail-order catalog organizations, telemarketing companies, help desks, and large organizations that use the telephone to sell or service products and to provide services to customers.

Typically, a call center receives telephone calls from callers and routes the calls to customer service representatives that service the call. Typically, a call center has the ability to concurrently handle a considerable volume of calls, to screen calls, to forward the calls to available representative, and to log calls.

### SUMMARY

In some embodiments, the invention includes a method for processing a telephone call at a call center. The method includes receiving at the call center a telephone call from a caller, retrieving information about the caller, examining a field that codes a predicted talkativeness trait for the caller, and determining a particular one of a plurality of customer service representatives to route the call to based on the predicted talkativeness trait for the caller.

Embodiments can include one or more of the following.

The predicted talkativeness trait can be inferred from observations of an average call times of other callers who demonstrate similar behaviors and demographics.

The method can also include authenticating the call. The method can also include routing the call to the determined particular customer service representative based upon the traits and temperament of those customer service representatives that enable them to more efficiently service talkative callers. The method can also include providing a first call script to be used by the customer service representative for callers with a certain first set of traits and temperament and providing a second call script to be used by the customer service representative for callers with a certain second set of traits and temperament, the first call script being different from the second call script. The method can also include determining a particular one of the first and second call scripts based on the determined traits and temperament of the caller and presenting the script on a user interface for the customer service representative. The method can also include updating the field based on observations of talkativeness the interaction during the call.

The caller information can be based on at least one of past interaction information, demographic data, questionnaire answers, and credit bureau data. Examples of traits and temperaments include aggressive, quarrelsome, needy, frequent callers, friendly chatters, prompt, self-directed, and no-nonsense. The particular one of the plurality of customer service representatives can include a particular group of customer service representatives.

In some embodiments, the invention includes a method that includes using data about a traits and temperament of a caller to reduce a call time for a call center. The traits and temperament are classified based on an assessment of a talkativeness trait of the caller.

Embodiments can include one or more of the following. Using knowledge about a the traits and temperament of a caller to reduce a call time can include selectively routing a call to a particular one of a plurality of customer service representatives based on the traits and temperament of the caller. Using knowledge about the traits and temperament of a caller to reduce a call time can include using a particular one of a plurality of call scripts based on the traits and temperament of the caller. The method can also include selectively routing the call to customer service representative based on a predicted traits and temperament of the customer service representative.

In some embodiments, the invention includes a computer program product residing on a computer readable medium for processing a telephone call at a call center. The computer program product includes instructions for causing a computing device in the call center to receive at the call center a telephone call from a caller, retrieve information about the caller, examine a field that is coded with a predicted talkativeness trait for the caller, and determine a particular one of a plurality of customer service representatives to route the call to based on the predicted talkativeness trait for the caller.

In some embodiments, the invention includes a call center for processing a telephone call. The call center includes an input device configured to receive a telephone call from a caller, a database comprising caller information for a plurality of callers, the database including a field that codes a predicted talkativeness trait for the caller, authentication software configured to retrieve caller information for the caller from the database, and routing software configured examine the field that codes the talkativeness trait for the caller to determine a particular one of a plurality of customer service representatives to route the call to based on the predicted talkativeness trait for the caller.

In some embodiments, the invention includes a method for determining a customer service representative to route a telephone call to at a call center. The method includes providing traits and temperament information associated with a plurality of customer service representatives, determining a traits and temperament of a caller, and matching the traits and temperament of the caller with a customer service representative having compatible traits and temperament. The traits and temperament can be associated with a predicted talkativeness trait.

In some embodiments, the invention includes a method for processing a telephone call at a call center. The method includes receiving at the call center a telephone call from a caller, retrieving information about the caller, and routing the call to a particular customer service representative based on a skill set of the customer service representative, a personality type of at least one of the caller and the customer service representative, and an availability indication for the customer service representative. The traits and temperament can be associated with a predicted talkativeness trait.

Advantages that can be seen in particular implementations include one or more of the following. In some embodiments, the routing of calls based on the predicted talkativeness of the caller can reduce the overall handle time of the call. Other features and advantages of the invention will become apparent from the following description, and from the claims.

### DESCRIPTION OF DRAWINGS

FIG. 1 is a block diagram of a call center including routing process.

FIG. 2 is a block diagram of the routing process.

FIG. 3 is a block diagram of a platform for a call center.

FIG. 4 is a block diagram of a customer record.

FIG. 5 is flow chart of a call routing process.

FIG. 6 is flow chart of a talkativeness trait determination process.

FIG. 7 is a talkativeness determination questionnaire.

FIG. 8 is block diagram of a process for dividing customer service representatives into multiple groups.

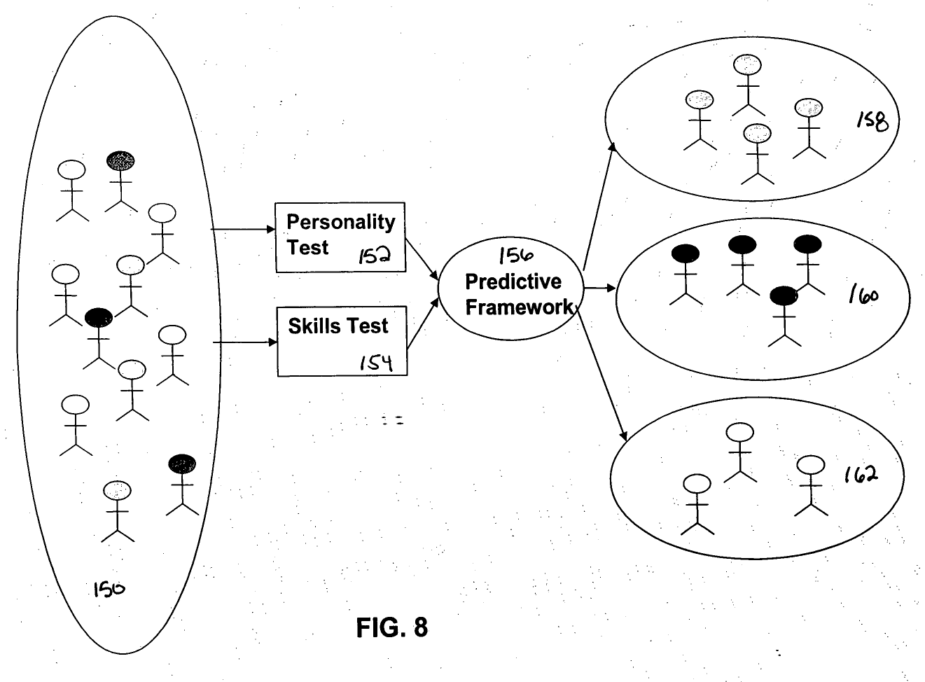

FIG. 9 is an exemplary table of average handle time for combinations of caller and customer service representative traits and temperaments.

FIG. 10 is an exemplary update questionnaire.

### DESCRIPTION

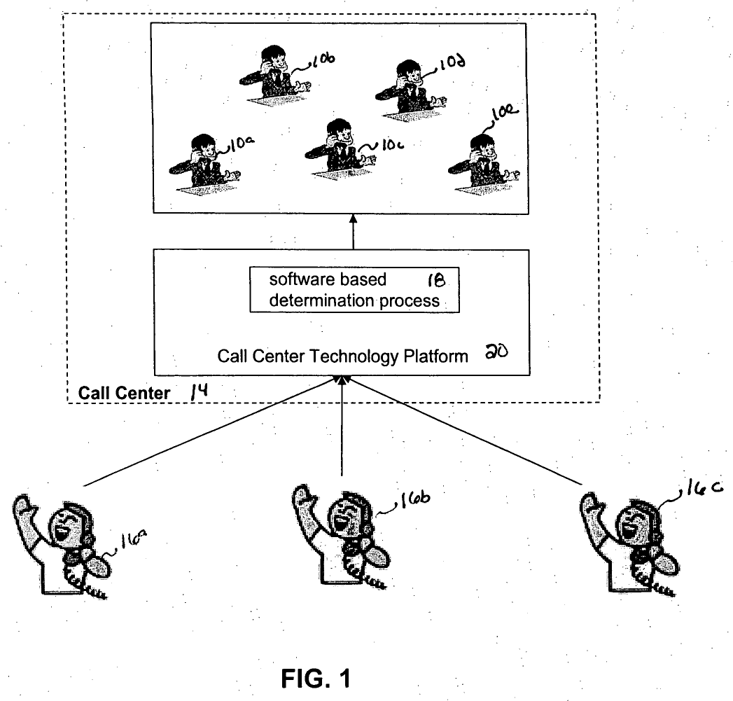

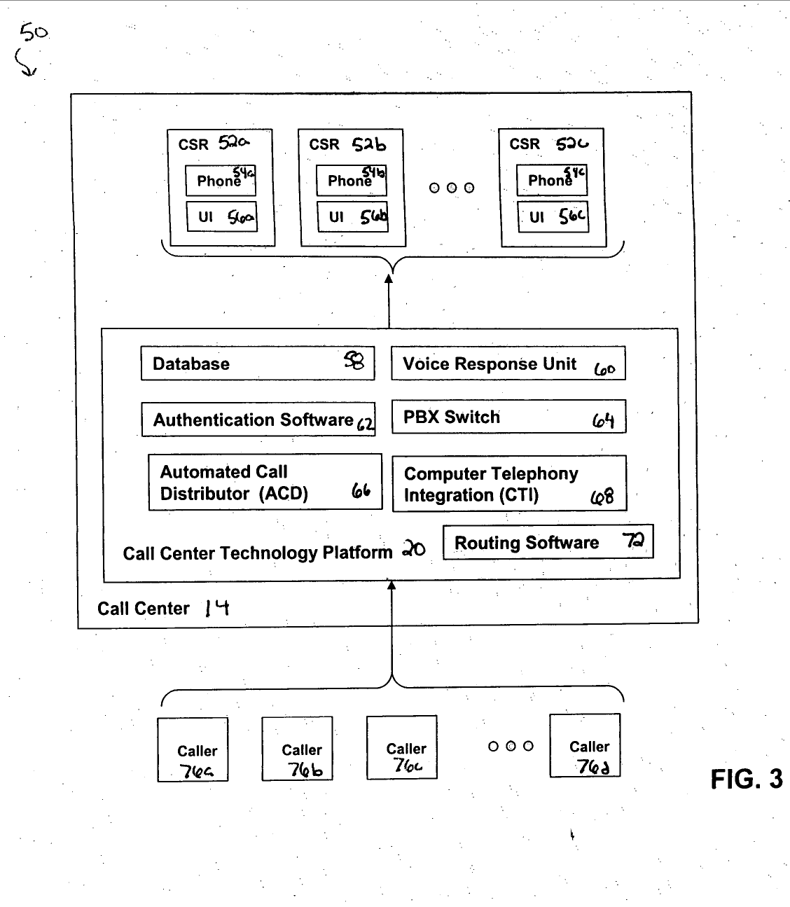

Referring to FIG. 1, typically, a call center 14 receives telephone calls from callers 16a-16c and routes the calls to customer service representatives 18a-18e that service the call. Typically, the call center 14 has the ability to concurrently handle a considerable volume of calls, to screen calls, to forward the calls to available representatives, and to log calls. The call center 14 includes a call center technology platform 20 (FIG. 3) that has the ability to route calls to specific ones of the customer service representatives, using a software based determination 18 of the traits and temperament of the caller.

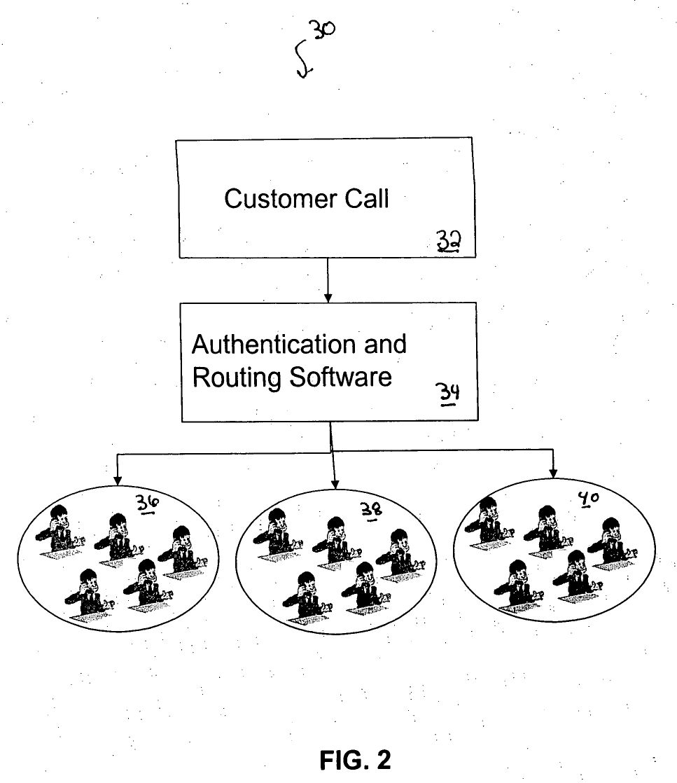

Referring to FIG. 2, a routing process 30 in which a call 32 from a customer is routed to a particular group of customer service representatives (CSRs) based on a predicted trait of the caller is shown. For example, the call can be routed based on a prediction of how talkative the caller will be. Authentication and routing software 34 determines the appropriate group of customer service representatives (e.g., groups 36, 38, and 40) to route the call to based on stored information about the traits and temperament of the caller. The authentication and routing software 34 also automatically routes the call to an available customer service representative in the determined group.

It is believed that routing calls based on a prediction of the traits and temperament, e.g., a prediction on the talkativeness of the caller can reduce the average handle time of the call (e.g., the total duration or length of the call). The traits and temperament of the caller can effect the average handle time. For example, with respect to callers, some callers can have traits and temperaments that are more talkative in comparison to other callers with different traits and temperaments. In addition, some service representatives can possess traits that make them more effective by at interacting with talkative individuals than others. By predicting the talkativeness of the caller before routing the call to a particular customer service representative, the call can be routed to a representative equipped with the skills or traits more efficiently handle the caller compared to other customer service representatives with different skills or temperaments.

Referring to FIG. 3, a plurality of callers 76a-d are in communication with a call center 14. In general, the call center 14 includes a call center technology platform 20 that selectively routes calls from callers 76a-76d to customer service representatives 52a-52c based on defined routing criteria. The customer service representatives 52a-52c receive information about the caller via a user interface 56a-56c and communicate with the callers via a phone 54a-54c. Information associated with the caller can include account information, recent calls and support questions, demographic information, and the like. In addition, the customer service representative 52a-52c may view a call script customized to the traits and temperaments of the caller which is displayed on the user interface 56a-56c.

The call center technology platform 20 includes software and systems for determining the identity of the caller 76a-76d and routing the call. The call center technology platform 20 includes a database 58, authentication software 62, an automated call distributor 66, a voice response unit 60, a switch 64, a computer telephony integration unit 68, and routing software 72. The voice response unit 68 and authentication software 62 can be used to receive input from the caller (e.g., an account number, name, or other identifying information) and determine the identity of the caller based on the information. The authentication software 62 can also access a database 58 that includes additional information about the caller such as the caller's predicted temperament which is used to selectively route the call.

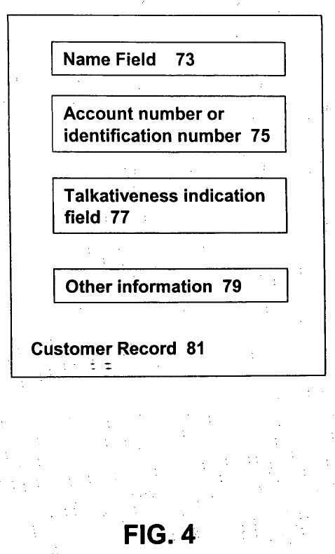

The routing software 72 determines a particular customer service representative 52a-52c to route the caller 76a-76g to based on the identity of the caller 76a-76d. For example, the database 58 can include a field that codes the talkativeness of the caller and the routing software 72 can selectively route the call based on a value of the code in the field. For example, referring to FIG. 4, database 58 can include customer records 81 for callers. The customer records can include a name field 73 that stores the name of a caller and an account number or identification number 75. The customer record 81 also includes a talkativeness indication field 77 that stores a single bit or multi-bit value that codes the talkativeness of the caller. The customer record 81 can also include other information or additional fields 79. The routing software determines a subset of those customer service representatives equipped to handle the caller's talkativeness (as indicated in field 73) and routes the caller to an available customer service representative from the determined group. The call center technology platform 20 also includes an automated call distributor 66 and switch 64 to facilitate the routing of the call to the determined customer service representative.

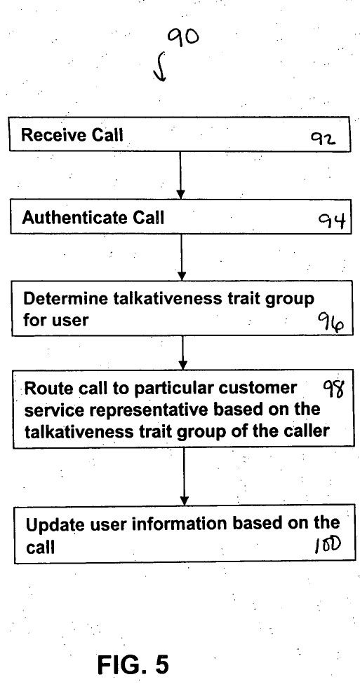

Referring to FIG. 5, a flow chart shows a process 90 for routing a call based on the talkativeness of the caller. The call center 14 receives 92 a call and authenticates 94 the call. The call authentication can include receiving information from the caller that can be used to determine the caller's identity. The call center technology platform 14 determines 96 the talkativeness trait group for the caller. The call center technology platform 14 routes 98 the call to a particular customer service representative based on the talkativeness trait group of the caller. After the completion of the call, the call center technology platform 14 can update 100 the talkativeness trait for the caller based on the duration and other qualitative factors about the call.

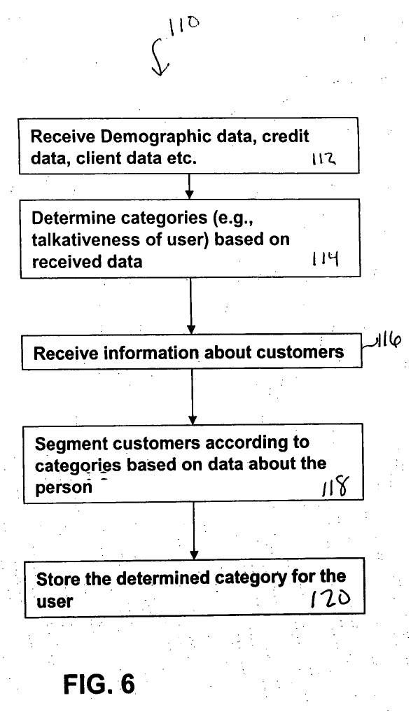

Thus, the call is routed based on the traits and temperament, e.g., the talkativeness of the caller. The talkativeness of the caller can be determined in a variety of ways. An exemplary process 110 is shown in FIG. 6. Initially, a large amount of data is collected 112 for a cross-section of individuals. This information can include demographic data, credit data, answers to survey questions, and the like. Based on the data, categories or indicators can be defined to indicate which callers are likely to have disproportionately long call times (e.g., which callers are more likely to be talkative). For example, individuals who are lonely or easily confused may require a longer call time in comparison to the average caller. By determining characteristics such as age, income, and interests that indicate a propensity to longer call times, the call time for a particular caller can be predicted based on personal information about the individual. In order to predict the talkativeness of a particular individual, data is also received 116 about customers or likely callers. This information is used to divide or place 118 the customers into a predicted category based on the likelihood that the individual will be talkative. This predicted category is stored 120 for use by the call center technology platform 14.

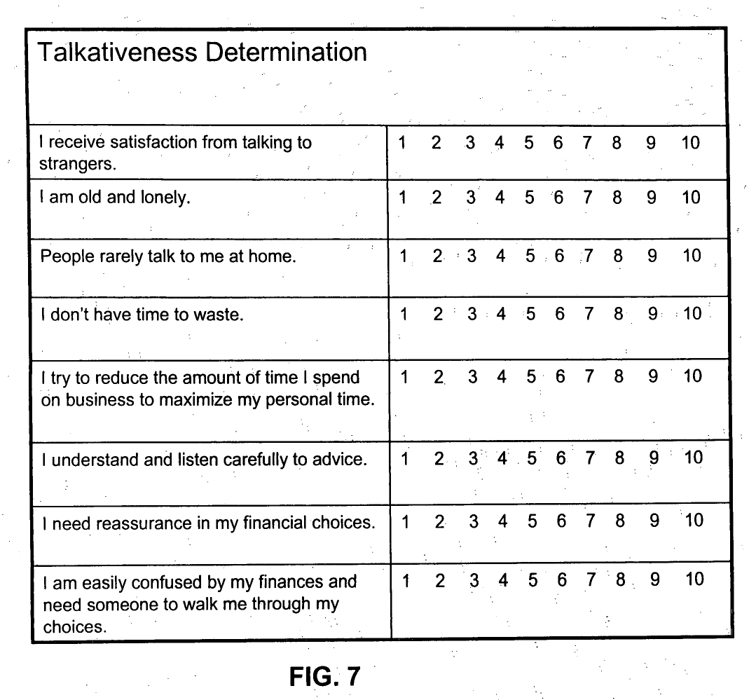

Referring to FIG. 7, a questionnaire with questions that gather data used by a process to determine the talkativeness of an individual and to predict the average call time for the individual is shown. By comparing the questionnaire answers to the handle time of callers, particular traits which lead to longer average call times can be determined and correlated to information about the identified group of callers as described in process 110.

In addition to dividing the callers based on their talkativeness, the customer service representatives are divided based on their ability to handle various types of callers. For example, some customer service representatives may be better able to efficiently handle calls from talkative individuals than other customer service representatives. In some embodiments, the customer service representatives are divided into various groups based on their actual handle time for a group of individuals. For example, a new customer service representative could be routed a predetermined number of calls and based on the average handle time of the calls, the ability of the customer service representative to interact effectively with and reduce the call time for a particular group of users exhibiting a particular talkativeness trait type could be determined. Alternatively, a new customer service representative could be routed calls from known talkativeness trait types. The handle time for those calls can be compared to average handle times of CRS's that handle the particular talkativeness trait type to see whether the new customer service representative is more or less efficient than the average.

Referring to FIG. 7, an alternative or additional method for dividing the customer service representatives based on a predictive method is shown. Based on a personality test 152 and a skills test 154 a predictive framework 156 groups the customer service representatives 150 into various groupings 158, 160, and 162 based on their abilities to interact with different personality types. The predictive framework 156 includes software to group the customer service representative's based on the information from the personality test 152 and a skills test 154. For example, the predictive framework can include mathematical algorithms used to weight various factors of the customer service representative's personality type and skills to determine or predict which grouping is most appropriate for the customer service representative. For example, a personality indicator test, such as those used by Myers Briggs, could be used to determine personality traits of the customer service representatives. Those traits can be correlated with the ability to reduce the call time for a particular type of caller. For example, individuals who are more patient may be able to reduce the average call time for callers who are upset or for angry callers. In addition, a skills based test 154 can provide valuable insight into the applied skills of the customer service representative. The skills test 154 can be used in combination with the personality test 152 to determine an appropriate group 158, 160, or 162 for the customer service representative.

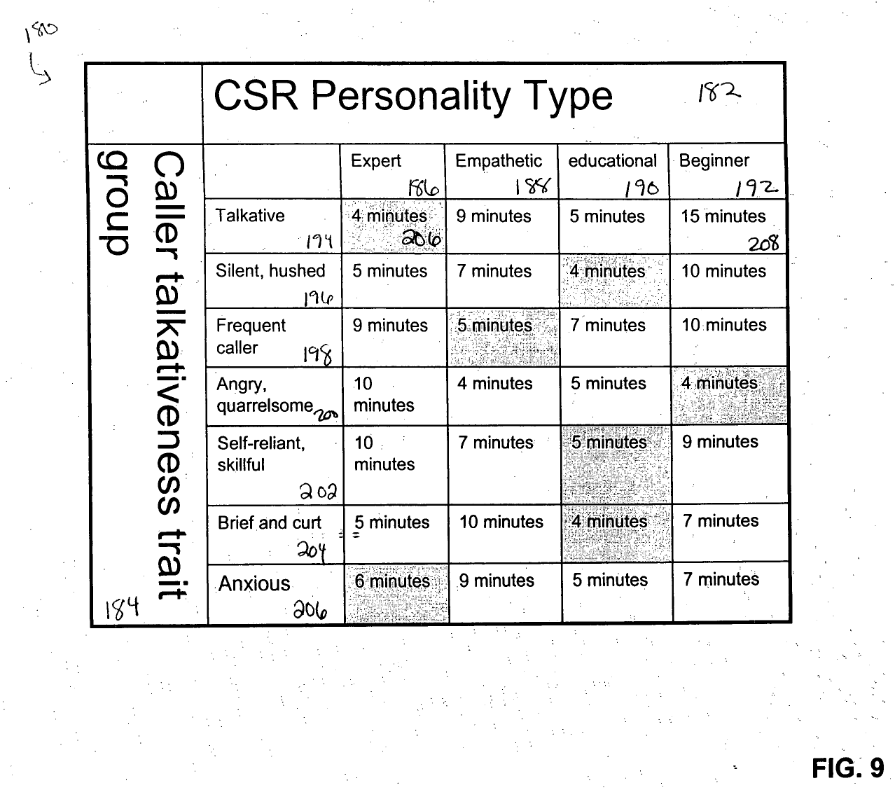

FIG. 9 shows a table 180 used to match the talkativeness trait group of the caller 184 to the personality type of a customer service representative 182 who would be most likely to reduce the average call time for that caller. By matching the traits and temperament of the caller 184 with the personality type of a customer service representative 182 who is best or most efficient at handling callers exhibiting particular traits or temperament, the overall handle time for the call can be reduced. The columns 182 of table 180 correspond to the personality type and/or skills of the customer service representative. Exemplary personality type groups for the customer service representatives include “expert” group 186, “empathetic” group 188, “educational” group 190, and “beginner” group 192. The rows 184 of table 180 correspond to the various traits and temperament types of the callers. The traits and temperaments types are based on the average call time such that callers of a particular traits and temperament type are expected to have similar average call times. Illustrative, call times are placed in the cells. Based on measured average call times, a match between the personality type of the customer service representative and the traits and temperament type of the caller which results in the lowest average call time can be determined. The match of the personality types is used to route the incoming caller to the matching customer service representative, such as by coding the traits and temperament type in the field 77 in FIG. 4. The routing process 90 can be configured to select a customer service representative according to e.g., a lookup in a table, a hard coded, or other technique to provide the customer service representative or customer service representative group that would yield the lowest expected call time.

For example, for the talkative group 194 the call times vary from 4 minutes with the expert customer service representative group 186 (as shown in cell 206) to 15 minutes for the beginner customer service representative group 192 (as shown in cell 208). In addition, the handle time for a particular customer service representative personality type can vary based on the caller traits and temperament type. It is believed that by matching the caller's traits and temperament type with the customer service representative personality type best able to handle such caller personalities, the average call time of calls to the call center can be reduced.

As described above, in some embodiments, the customer service representative can update the talkativeness indicator of the individual based on characteristics of a completed call. In some embodiments, the customer service representative manually updates or changes the traits and temperament type or talkativeness indicator based on their intuition and personal analysis of the call. In other embodiments, the customer service representative can rate the caller and the rating can be factored into the traits and temperament type for the individual. In other embodiments, the customer service representative responds to a series of questions about the call and the system automatically calculates and adjusts the talkativeness associated with the individual based on the customer service representative's responses.

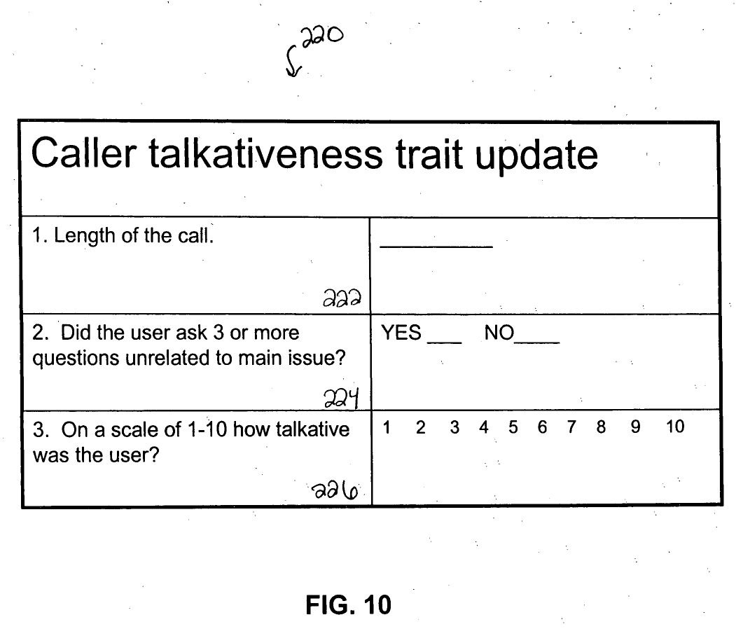

For example, as shown in FIG. 10, upon completion of a call, the customer service representative views an update survey 220. The update survey includes a list of questions that the customer service representative responds to based on the characteristics of the call and the caller. For example, the update survey 220 can include a question about the length of the call 222. The length of the call can be populated either manually by the customer service representative or automatically. The survey can also include questions about the call. For example, the survey could include a question about the number of unrelated comments or questions posed by the caller 224 and a subjective indication of the talkativeness of the caller 226. Other questions or characteristics of the call can also be included in the update survey 220.

Based on the answers to the questions, the system compares the responses to other calls and determines if the talkativeness type for the caller should be adjusted. For example, if the call time is significantly greater than the call time for the caller's talkativeness type and the customer service representative rates the person as extremely talkative then the caller may be re-classified into a group that is more talkative.

In addition to selectively routing callers based on their talkativeness, other methods can additionally or alternatively be used to reduce the average call time based on the talkativeness of the caller. For example, different call scripts can be used for different traits and temperament types of the caller. For example, the customer service representative can receive on the user interface a call script customized based on the talkativeness of the caller. Thus, different call scripts will be used for different traits and temperament types and the call scripts can be generated to shorten the average call time for the particular traits and temperament type based on the talkativeness of the caller.

In some embodiments, the call script could include a list of short transition phrases. It is believed that providing a list of pre-formulated transition phrases can reduce the average length of a call. Exemplary transition phrases could include phrases such as: “I know your time is limited,” “Did I answer all of your questions?”, “Can we get back to you on that?”, and “Are you satisfied?”. The pre-formulated transition phrases can help the customer service representative to rapidly transition from one topic to another and to keep the call moving. In addition, the transition phrases can be formulated to promote a short and to-the-point answer from the caller rather than providing an open-ended question which is likely to result in a lengthy response.

Other embodiments are within the scope of the following claims.

What is claimed is:

1. A method for processing a telephone call at a call center, the method comprising:
receiving at the call center a telephone call from a caller;
retrieving information about the caller; and
examining a field that codes a predicted talkativeness trait for the caller;
determining a particular one of a plurality of customer service representatives to route the call to based on the predicted talkativeness trait for the caller.

2. The method of claim 1, wherein the predicted talkativeness trait is based on how the caller will interact with the customer service representative.

4. The method of claim 1, further comprising authenticating the call.

5. The method of claim 1, further comprising:
routing the call to the determined particular customer service representative.

6. The method of claim 5, further comprising providing a first call script to be used by the customer service representative for callers with a certain first set of traits and temperament; and
providing a second call script to be used by the customer service representative for callers with a certain first set of traits and temperament, the first call script being different from the second call script.

7. The method of claim 6, further comprising:
determining a particular one of the first and second call scripts based on the determined talkativeness trait of the caller; and
presenting the script on a user interface for the customer service representative.

8. The method of claim 7, further comprising:
updating the field based on observations of talkativeness the interaction during the call.

9. The method of claim 1, wherein the caller information is based on at least one of past interaction information, demographic data, questionnaire answers, and credit bureau data.

10. The method of claim 1, wherein the personality type includes at least one of aggressive, quarrelsome, needy, frequent callers, friendly chatters, to-the-point, prompt, self-directed, and no-nonsense.

11. The method of claim 1, wherein the particular one of the plurality of customer service representatives comprises a particular group of customer service representatives.

12. A method comprising:
using data about a temperament of a caller to reduce a call time for a call center, wherein the temperament is classified based on an assessment of a talkativeness trait of the caller.

13. The method of claim 12, wherein using knowledge about a temperament type of a caller to reduce a call time comprises:
selectively routing a call to a particular one of a plurality of customer service representatives based on the temperament type of the caller.

14. The method of claim 12, wherein using knowledge about a temperament type of a caller to reduce a call time comprises:
using a particular one of a plurality of call scripts based on the temperament type of the caller.

15. The method of claim 12, further comprising selectively routing the call to customer service representative based on a predicted temperament type of the customer service representative.

16. A computer program product residing on a computer readable medium for processing a telephone call at a call center, the computer program product comprising instructions for causing a computing device in the call center to:
receive at the call center a telephone call from a caller;
retrieve information about the caller; and
examine a field that codes a predicted talkativeness trait for the caller;
determine a particular one of a plurality of customer service representatives to route the call to based on the predicted talkativeness trait for the caller.

17. A call center for processing a telephone call comprising:
an input configured to receive a telephone call from a caller;
a database comprising caller information for a plurality of callers, the database including a field that codes a predicted talkativeness trait for the caller;
authentication software configured to retrieve caller information for the caller from the database; and
routing software configured to examine the field that codes the talkativeness trait for the caller to determine a particular one of a plurality of customer service representatives to route the call to based on the predicted talkativeness trait for the caller.

18. A method for determining a customer service representative to route a telephone call to at a call center, the method comprising:
providing personality type information associated with a plurality of customer service representatives;
determining a personality type of a caller;
routing a call to a particular service representative based on a match between the personality type of the caller and a personality type of the customer service representative, the personality type of the caller being compatible with the personality type of the customer service representative having a compatible personality type.

19. The method of claim 18, wherein the personality type is associated with a predicted talkativeness trait.

20. A method for processing a telephone call at a call center, the method comprising:
receiving, at the call center, a telephone call from a caller;
retrieving information about the caller; and
routing the call to a particular customer service representative based on a skill set of the customer service representative, a personality type of at least one of the caller and the customer service representative, and an availability indication for the customer service representative.

21. The method of claim 20, wherein the personality type is associated with a predicted talkativeness trait.
